(19) United States
(12) Patent Application Publication
(10) Pub. No.: US 2024/0264351 A1
(43) Pub. Date: Aug. 8, 2024

(54) POLARIZING PLATE AND OPTICAL DISPLAY APPARATUS

(71) Applicant: SAMSUNG SDI CO., LTD., Yongin-si (KR)

(72) Inventors: Dae Gyu LEE, Suwon-si (KR); Seong Heun CHO, Suwon-si (KR); Eun Hwa LEE, Suwon-si (KR); Jin Ah SEO, Suwon-si (KR); Hyun Ah HONG, Suwon-si (KR); Jang Hyun CHO, Suwon-si (KR)

(21) Appl. No.: 18/416,627

(22) Filed: Jan. 18, 2024

(30) Foreign Application Priority Data
Jan. 19, 2023 (KR) 10-2023-0007953

(51) Int. Cl. G02B 5/30

(52) U.S. Cl. CPC G02B 5/305; G02B 5/3008

(57) ABSTRACT

A polarizing plate and an optical display apparatus including the same are provided. A polarizing plate includes: a polarizer; and an optically functional layer stacked on a surface of the polarizer, and the optically functional layer includes an alkylene glycol group-containing matrix and anisotropic particles including acicular particles, the acicular particles being aligned with respect to a light absorption axis of the polarizer in an in-plane direction of the optically functional layer.

### CROSS-REFERENCE TO RELATED APPLICATION

The present application claims priority to and the benefit of Korean Patent Application No. 10-2023-0007953, filed on Jan. 19, 2023 in the Korean Intellectual Property Office, the entire disclosure of which is incorporated herein by reference.

### BACKGROUND

### 1. Field

Aspects of embodiments of the present invention relate to a polarizing plate and an optical display apparatus including the same.

### 2. Description of the Related Art

A liquid crystal display has a structure wherein a viewer-side polarizing plate, a liquid crystal panel, and a light source-side polarizing plate are sequentially stacked.

Despite many advantages, the liquid crystal display has problems of low visibility and low brightness at a lateral side thereof. To solve these problems, the viewer-side polarizing plate may further include a visibility-enhancing layer, which includes two resin layers having different indexes of refraction and has a pattern at an interface therebetween. However, such a visibility-enhancing layer can cause deterioration in processability due to formation of the pattern, thereby causing low yield and a limit in reduction of manufacturing costs. Accordingly, there is a need for a polarizing plate capable of improving visibility even without such a visibility-enhancing layer. Since the viewer-side polarizing plate is disposed at the outermost side of the liquid crystal display, the viewer-side polarizing plate is vulnerable to external impact. Therefore, the viewer-side polarizing plate is required to have high hardness.

On the other hand, polarizing plates are commonly transported in the form of a stack or roll of multiple polarizing plates. In addition, when the polarizing plate is attached to a panel, the wound polarizing plate is unwound and then attached thereto. During this process, the polarizing plate can be bonded to the panel in a bent state. Poor bendability (flexibility) of the polarizing plate can cause transfer failure of the polarizing plate and poor attachment of the polarizer to the panel.

The background technique of the present invention is disclosed in Korean Patent Laid-open Publication No. 10-2018-0047569 and the like.

### SUMMARY

According to an aspect of embodiments of the present invention, a polarizing plate capable of enhancing contrast ratio even without a pattern, for example, a contrast ratio-enhancing pattern, or a contrast ratio-enhancing layer having a pattern, is provided.

According to another aspect of embodiments of the present invention, a polarizing plate that has improved bendability and suppresses generation of curls is provided.

According to another aspect of embodiments of the present invention, a polarizing plate having good scratch resistance and high hardness is provided.

According to another aspect of embodiments of the present invention, a polarizing plate having good processability is provided.

According to an aspect of the present invention, a polarizing plate is provided.

According to one or more embodiments, a polarizing plate includes a polarizer; and an optically functional layer stacked on a surface of the polarizer, wherein the optically functional layer includes an alkylene glycol group-containing matrix and anisotropic particles including acicular particles, the acicular particles being aligned with respect to a light absorption axis of the polarizer in an in-plane direction of the optically functional layer.

According to another aspect of the present invention, an optical display apparatus is provided.

The optical display apparatus includes the polarizing plate according to an embodiment of the present invention.

Embodiments of the present invention provide a polarizing plate capable of enhancing contrast ratio even without a pattern, for example, a contrast ratio-enhancing pattern, or a contrast ratio-enhancing layer having a pattern.

Further, embodiments of the present invention provide a polarizing plate that has improved bendability and suppresses generation of curls.

Further, embodiments of the present invention provide a polarizing plate that has good scratch resistance and high hardness.

Further, embodiments of the present invention provide a polarizing plate that has good processability.

### BRIEF DESCRIPTION OF THE DRAWINGS

FIG. 1 is a schematic cross-sectional view of an acicular particle.

FIG. 2 is a perspective view of an optically functional layer according to an embodiment of the present invention.

FIG. 3 is a schematic diagram showing a distribution of angles of longitudinal directions of acicular particles with respect to a reference plane, assuming that the light absorption axis of the polarizer is placed at 90° with respect to the reference plane.

FIG. 4 is a diagram showing a distribution of orientation angles of the acicular particles in the optically functional layer.

FIG. 5 to FIG. 9 are cross-sectional views of polarizing plates according to embodiments of the present invention.

### DETAILED DESCRIPTION

Herein, some example embodiments of the present invention will be described in further detail with reference to the accompanying drawings such that the present invention can be implemented by those skilled in the art. However, it is to be understood that the present invention may be embodied in different ways and is not limited to the following embodiments.

The terminology used herein is for the purpose of describing example embodiments and is not intended to limit the scope of the invention. Herein, the singular forms “a,” “an,” and “the” are intended to include the plural forms as well, unless the context clearly indicates otherwise.

In the drawings, portions irrelevant to the description may be omitted for clarity and like components are denoted by like reference numerals throughout the specification.

Herein, spatially relative terms, such as “upper” and “lower,” are defined with reference to the accompanying drawings. Thus, it is to be understood that “upper surface” can be used interchangeably with “lower surface” and vice versa. When an element is referred to as being formed “directly on,” “immediately on,” or “to directly adjoin” another element, there are no intervening element(s) therebetween.

Herein, “in-plane retardation (Re)” is a value measured at a wavelength of 550 nm, as calculated according to Equation A:

$$Re = ( n x - ny ) \times d , \qquad ( A )$$

where nx and ny are the indexes of refraction of a protective layer in the slow axis direction and the fast axis direction thereof at a wavelength of 550 nm, respectively, and d is the thickness (unit: nm) of the protective layer.

Herein, “(meth)acryl” refers to acryl and/or methacryl.

Herein, “index of refraction” may be a value measured at a wavelength of 380 nm to 780 nm, or at 550 nm.

Herein, “light transmittance” may be a value measured at a wavelength of 380 nm to 780 nm, or at 550 nm.

As used herein to represent a specific numerical range, “X to Y” means “X≤ and ≤Y”.

According to an embodiment, a polarizing plate provides an effect of improving contrast ratio even without a pattern or a contrast ratio-enhancing layer including resin layers having a pattern at an interface therebetween. In embodiments, the polarizing plate achieved significant improvement in lateral contrast ratio, as compared to a polarizing plate without the contrast ratio-enhancing layer. The polarizing plate exhibited frontal and lateral contrast ratios similar to those of a polarizing plate having a pattern or a contrast ratio-enhancing layer including resin layers having a pattern at an interface therebetween. As a result, the polarizing plate can achieve reduction in thickness thereof. According to an embodiment, a polarizing plate that has improved bendability and suppresses generation of curls is provided. As a result, the polarizing plate provides good processability upon transfer and attachment of the polarizing plate to a panel and is applicable not only to a non-flexible optical display apparatus but also to a flexible display apparatus. According to an embodiment, a polarizing plate that has good scratch resistance and high hardness is provided. As a result, the polarizing plate can be efficiently used as a viewer-side polarizing plate.

According to an embodiment, a polarizing plate includes a polarizer; and an optically functional layer stacked on a surface of the polarizer, wherein the optically functional layer includes an alkylene glycol group-containing matrix and anisotropic particles including acicular particles, and the acicular particles are aligned in an in-plane direction of the optically functional layer. According to embodiments of the present invention, the acicular particles are contained in the optically functional layer, particularly in the alkylene glycol group-containing matrix to form the optically functional layer, thereby improving lateral relative contrast ratio while achieving improvement in bendability (flexibility) of the polarizing plate and suppression of curls.

In one or more embodiments, the polarizing plate may have a light transmittance of 35% or more, for example, 40% to 45%. Within this range, the polarizing plate can be used as a viewer-side polarizing plate.

Next, a polarizing plate according to an embodiment of the present invention will be described further.

### Optically Functional Layer

The optically functional layer may be formed on a surface of the polarizer, and, in an embodiment, on a light exit surface of the polarizer. Here, the light exit surface refers to a surface through which light emitted from a backlight unit and having reached the polarizer exits from the polarizer.

The optically functional layer includes anisotropic particles.

The anisotropic particles include acicular particles. According to embodiments of the present invention, the optically functional layer includes acicular particles among various kinds of anisotropic particles. The present invention uses properties of the acicular particles that secure particularly good effects in improvement in visibility and contrast ratio at front and lateral sides by providing different degrees of diffusing light received from a backlight unit, and, in an embodiment, from the polarizer, depending upon the index of refraction and orientation direction of the acicular particles. Accordingly, the optically functional layer may have flat (totally flat) upper and lower surfaces, as shown in the drawings.

Next, the acicular particles will be described in further detail.

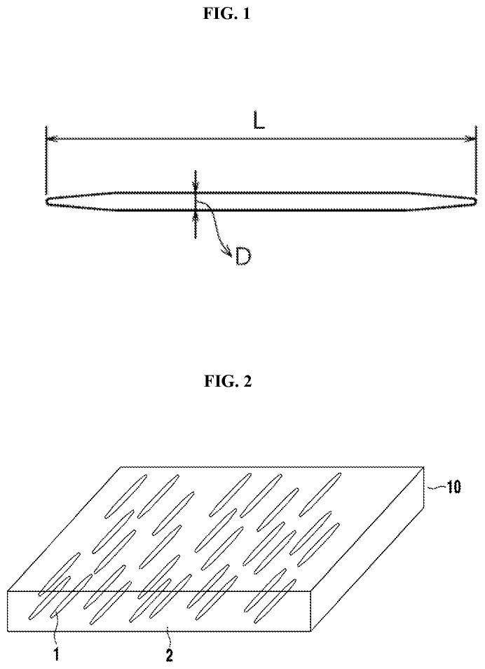

FIG. 1 is a schematic cross-sectional view of an acicular particle.

The acicular particles may have a length L and a diameter D, which is not uniform over the entire length L and gradually decreases towards both ends of the acicular particle. The acicular particles with an uneven thickness exhibit optical anisotropy, whereby incident light emitted from the polarizer can travel in different directions while passing through the acicular particles.

FIG. 1 shows an acicular particle having a diameter gradually decreasing from a center thereof to both ends thereof. However, it is to be understood that the present invention is not limited thereto, and the acicular particles may have a diameter that is uniform from the center thereof to an end thereof while gradually decreasing from the center to another end thereof, depending on a method of preparing the acicular particles.

The acicular particles may be acicular microparticles having a length L of a micrometer-scale value. Here, “micrometer-scale value” means that the length L is 1 μm or more. With this structure, the acicular microparticles allow easy adjustment of the average value and standard deviation of the orientation angles thereof and thus can assist in improvement in contrast ratio and brightness. However, acicular nanoparticles having a nanometer-scale length L (for example, nano-rods, acicular nanoparticles) do not allow easy orientation in a desired direction, thereby making it difficult to achieve the effects of the invention. If an excess of the acicular nanoparticles is present to achieve the same effects as the acicular microparticles, there can be a problem of deterioration in optical properties, such as light transmittance, haze, and the like.

In an embodiment, the acicular particles may have a length L of 10 μm to 50 μm, for example, 10 μm to 30 μm, or 15 μm to 28 μm. Within this range, the acicular particles can be easily aligned in a desired direction, thereby assisting in improvement in contrast ratio and brightness.

In an embodiment, the acicular particles may have a cross-sectional diameter D of 0.5 μm to 2.0 μm, and, in an embodiment, 1 μm to 2.0 μm. Within this range, the acicular particles can provide lateral diffusion through increase in aspect ratio thereof. Here, “cross-sectional diameter” is a diameter of the acicular particles in cross-sectional view and may mean the maximum diameter of the acicular particles among diameters measured in cross-section.

In an embodiment, the acicular particles may have a circular or elliptical cross-section.

In an embodiment, the acicular particles may have an average aspect ratio of 5 or more, for example, 5 to 60. Within this range, the acicular particles can easily provide an effect of improving contrast ratio and brightness. In an embodiment, the acicular particles may has an average aspect ratio of 10 to 50, and, in an embodiment, 10 to 30, 10 to 20, or 10 to 18. Here, “average aspect ratio” refers to an average of aspect ratios of the acicular particles and “aspect ratio” refers to a length-to-maximum diameter ratio of each of the acicular particles.

As the anisotropic particles, the acicular particles are aligned in an in-plane direction of the optically functional layer. According to embodiments of the present invention, the acicular particles are aligned at least in one orientation angle in the in-plane direction of the optically functional layer instead of being randomly aligned, thereby improving brightness and contrast ratio at a lateral side. Accordingly, the optically functional layer may act as a contrast ratio, visibility, and/or brightness-enhancing layer.

Referring to FIG. 2, an optically functional layer 10 includes acicular particles 1 and a matrix 2, into which the acicular particles 1 are impregnated. The acicular particles 1 are orientated in one direction in the in-plane direction of the optically functional layer 10.

As described below, each of upper and lower surfaces of the optically functional layer is totally flat and is not patterned. Nevertheless, the optically functional layer can improve visibility, contrast ratio and/or brightness at front and lateral sides by containing the acicular particles while satisfying orientation of the acicular particles in one direction in the in-plane direction. As a result, the polarizing plate can improve manufacturing processability while achieving thickness reduction through elimination of an optical pattern or a contrast ratio-enhancing layer.

In an embodiment, assuming that the light absorption axis of the polarizer is 0°, orientation angles of the acicular particles defined between a light absorption axis of the polarizer and the longitudinal directions of the acicular particles have an average value of −10° to +10° and a standard deviation of 15° or less. Within the ranges of the average value and standard deviation, the polarizing plate can achieve significant improvement in contrast ratio and/or brightness at front and lateral sides thereof. If the polarizing plate does not satisfy any one of the average value and the standard deviation, the polarizing plate can exhibit insignificant improvement in contrast ratio and/or brightness.

Here, “orientation angle” means an angle defined between the light absorption axis of the polarizer and the longitudinal direction of the acicular particle, assuming that the light absorption axis of the polarizer is 0°. A spherical particle, particularly an isotropic particle, which does not have a longitudinal direction, does not have an orientation angle.

According to embodiments of the present invention, the orientation angles of the acicular particles have an average value of −10° to +10° and a standard deviation of 15° or less, such that light emitted from the polarizer can travel in different directions through the acicular particles, thereby improving front/lateral contrast ratio and brightness. For example, the orientation angles of the acicular particles may have an average value of −10°, −9°, −8°, −7°, −6°, −5°, −4°, −3°, −2°, −1°, 0°, +1°, +2°, +3°, +4°, +5°, +6°, +7°, +8°, +9°, or +10°, and a standard deviation of 0°, 1°, 2°, 3°, 4°, 5°, 6°, 7°, 8°, 9°, 10°, 11°, 12°, 13°, 14°, or 15°. Accordingly, the optically functional layer may be a contrast ratio and/or visibility-enhancing layer. The light absorption axis of the polarizer may be a machine direction (MD) of the polarizer.

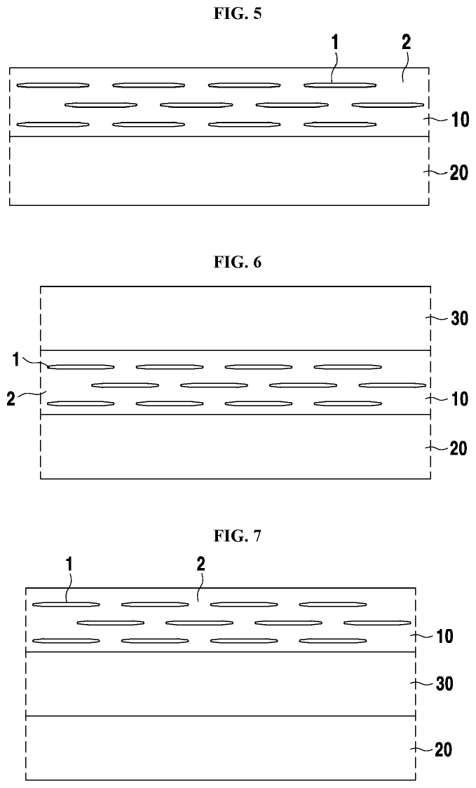

Next, the average value and standard deviation of the orientation angles will be described with reference to FIGS. 4, 5A, and 5B.

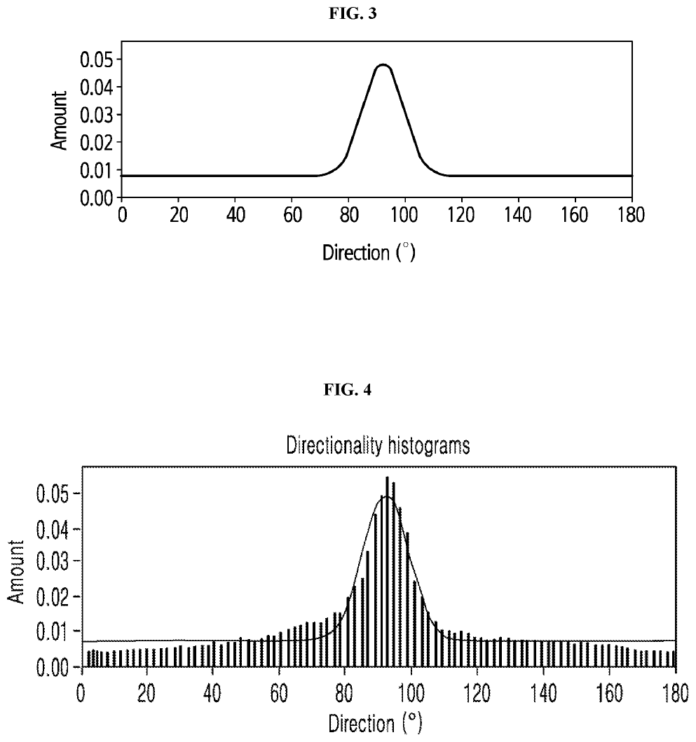

FIG. 3 is a schematic diagram showing a distribution of angles of the longitudinal directions of the acicular particles with respect to a reference plane, assuming that the light absorption axis of the polarizer is placed at 90° with respect to the reference plane. FIG. 4 is a diagram showing a distribution of the orientation angles of the acicular particles in the optically functional layer.

According to the present invention, the average value of the orientation angles of the acicular particles is obtained by calculating the average of the angles, followed by subtracting 90° from the calculated average of the angles (calculated average of the angles −90°). For example, when the calculated average is 80°, the average value of the orientation angles is −10° and, when the calculated average is 100°, the average value of the orientation angles is +10°. The standard deviation of the orientation angles may be calculated from the distribution of the angles by a typical method known in the art.

In an embodiment, the average value of the orientation angles may be in a range from −4.0° to +4.0°, and, in an embodiment, −2.5° to +2.5°, and, in an embodiment, −1.5° to +1.5°, and the standard deviation of the orientation angles may be in a range from 0° to 8.5°, and, in an embodiment, 5° to 8.5°. Within these ranges, the polarizing plate can more efficiently achieve the effects of the present invention.

In an embodiment, at least 90%, for example, 95% to 100%, of the acicular particles may be aligned at an orientation angle of −10° and +10°. Within this range, the optically functional layer can provide uniform or substantially uniform contrast ratio and improved visibility. Here, “%” means a weight ratio of the acicular particles aligned at an orientation angle of −10° to +10° to the total acicular particles in the optically functional layer.

In an embodiment, the acicular particles may have an index of refraction of 1.5 to 2.2, and, in an embodiment, 1.6 to 1.8, and, in an embodiment, 1.65 to 1.7. Within this range, the acicular particles can have a suitable index of refraction relative to a resin layer (or matrix) described below, thereby assisting in improvement in contrast ratio and visibility.

The acicular particles may be selected from among organic particles, inorganic particles, organic-inorganic particles, and the like. For example, the acicular particles may be formed of at least one selected from among metal oxides, such as titanium oxide (for example, TiO₂), zirconium oxide (for example, ZrO₂), and zinc oxide (for example, ZnO), metal compounds, such as calcium carbonate (CaCO₃), Boehmite, aluminum borate (for example, AlBO₃), calcium silicate (for example, CaSiO₃, wollastonite), magnesium sulfate (MgSO₄), magnesium sulfate hydrate (for example, MgSO₄·7H₂O), and potassium titanate (for example, K₂Ti₈O₁₇), inorganic particles, such as glass, and organic particles, such as synthetic resins, and the like. In an embodiment, the acicular microparticles are formed of calcium carbonate to facilitate preparation thereof and achievement of the effects of the invention.

The acicular particles may be impregnated into the optically functional layer without surface modification. However, surface modification of the acicular particles can further improve compatibility of the acicular particles with a matrix formed of an organic material described below and dispersibility of the acicular particles in the matrix to improve optical properties of the optically functional layer without aggregation of the acicular particles, thereby facilitating achievement of the effects of the present invention. In an embodiment, the acicular particles may be subjected to surface modification over 50% or more, for example, 60% to 100%, or 60% to 95% of the entire surface area thereof. Within this range, the acicular particles can have improved compatibility and dispersibility.

In an embodiment, the acicular particles may be subjected to surface modification with at least one selected from among a silane based compound, a surfactant, and oils. For example, the acicular particles may be subjected to surface treatment with a silane based compound having a (meth)acryloyloxy group or a (meth)acrylate group to have good compatibility with a matrix of a resin layer formed of an actinic radiation curable composition described below and good dispersibility in the matrix.

The silane based compound having the (meth)acryloyloxy group or the (meth)acrylate group may include at least one selected from among 3-(meth)acryloyloxypropylmethyldimethoxysilane, 3-(meth)acryloyloxypropyltrimethoxysilane, 3-(meth)acryloyloxypropylmethyldiethoxysilane, 3-(meth)acryloyloxypropyl triethoxysilane, and 3-(meth)acryloyloxypropyltrimethoxysilane. In an embodiment, the silane based compound having the (meth)acryloyloxy group or the (meth)acrylate group includes 3-(meth)acryloyloxypropyltrimethoxysilane and/or 3-(meth)acryloyloxypropyl triethoxysilane.

In an embodiment, the acicular particles may be present in an amount of 90% or more, for example, 95% to 100%, or 100%, based on the total amount of the anisotropic particles in the optically functional layer. Within this range, the effects of the present invention can be easily achieved. Here, “%” means a weight ratio of the acicular particles to the total anisotropic particles in the optically functional layer.

In an embodiment, the anisotropic particles, for example, the acicular particles, may be present in an amount of 1 wt % to 30 wt %, for example, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, or 30 wt %, and, in an embodiment, 1 wt % to 20 wt %, and, in an embodiment, 1 wt % to 10 wt %, in the optically functional layer. Within this range, the polarizing plate can achieve improvement in contrast ratio and brightness. However, an excess of the acicular particles can cause an increase in haze.

In an embodiment, the anisotropic particles, and, in an embodiment, the acicular particles, may be present in an amount of 90 wt % or more, for example, 95 wt % to 100 wt %, based on the total amount of the inorganic particles in the optically functional layer.

The optically functional layer includes the matrix impregnated with the acicular particles as the anisotropic particles, and containing an alkylene glycol group.

According to one or more embodiments of the present invention, when the acicular particles are contained in the optically functional layer, the matrix for the optically functional layer is formed using an alkylene glycol group-containing monomer. With this structure, the polarizing plate according to the present invention has improved bendability and suppresses generation of curls. An alkylene glycol group-free monomer provides insignificant improvement in bendability and curl suppression of the optically functional layer.

By way of example, the polarizing plate may be evaluated as to bendability using a mandrel rod having a diameter of 10 mm or less, for example, greater than 0 mm to 10 mm. The polarizing plate can have good flexibility and can be used in a foldable display apparatus.

By way of example, the polarizing plate may have a curl length of 30 mm or less, for example, greater than 0 mm to 20 mm, in curl evaluation. Within this range, the polarizing plate can secure good processability in transfer and attachment of the polarizing plate to a panel.

The alkylene glycol group means *—(—O—R—)—*, where * is a linking site between elements and R is a substituted or unsubstituted C₁ to C₅ alkylene group.

In an embodiment, R is an unsubstituted linear or branched C₁ to C₅ alkylene group, for example, an ethylene group, an n- or iso-propylene group, or an n- or iso-butylene group. In an embodiment, the alkylene glycol group may be an ethylene glycol group, an n-propylene glycol group, an iso-propylene glycol group, an n-butylene glycol group, or an iso-butylene glycol group.

In an embodiment, the alkylene glycol group in the matrix may be represented by the following Formula 1:

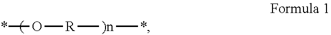

where * is a linking site between elements; R is a substituted or unsubstituted linear or branched C₁ to C₅ alkylene group; and n is an integer of 1 or more.

For example, n may be an integer of 1 to 9, 1 to 5, or 1 to 3.

For example, R may be an unsubstituted linear or branched C₁ to C₅ alkylene group.

For example, the alkylene glycol group in the matrix may be —(—O—CH₂CH₂—)—, —(—O—CH₂CH₂—)₂—, —(—O—CH₂CH₂—)₃—, —(—O—CH₂CH₂CH₂—)—, —(—O—CH₂CH₂CH₂—)₂—, —(—O—CH₂CH₂CH₂—)₃—, —(—O—CHCH₃CH₂—)—, —(—O—CHCH₃CH₂—)₂—, —(—O—CHCH₃CH₂—)₃—, —(—O—CH₂CH₂CH₂CH₂—)—, —(—O—CH₂CH₂CH₂CH₂—)₂—, or —(—O—CH₂CH₂CH₂CH₂—)₃—.

The alkylene glycol group may be derived from the alkylene glycol group-containing monomer in consideration of ease of provision thereof to the matrix.

In an embodiment, the alkylene glycol group-containing monomer may be a polyfunctional monomer. As a result, the alkylene glycol group-containing monomer can improve scratch resistance and hardness of the optically functional layer.

In an embodiment, the alkylene glycol group-containing monomer may be a tri- or higher polyfunctional, tri- to hexa-functional monomer. In an embodiment, the polarizing plate may have a pencil hardness of 2H or more, for example, 2H to 4H, as measured in accordance with ASTM D3502. Within this range, the optically functional layer is resistant to external impact and can be sufficiently used as a viewer-side polarizing plate.

In an embodiment, the alkylene glycol group-containing monomer may include at least one selected from among compounds represented by the following Formulas 2 and 3.

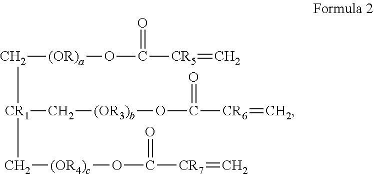

where: R₁ is hydrogen, a C₁ to C₅ alkyl group, or *—CH₂—(—ORₐ—)—O—(C═O)—CR_{b}═CH₂ (*being a linking site between elements, Ra being a C₂ to C₅ alkylene group, Rb being hydrogen or a methyl group; R₂, R₃, and R₄ are each independently a substituted or unsubstituted, linear or branched C₂ to C₅ alkylene group; R₅, R₆, and R₇ are each independently hydrogen or a methyl group; and a, b, and c are each independently 0 or an integer of 1 or more, 1≤a+b+c≤35.

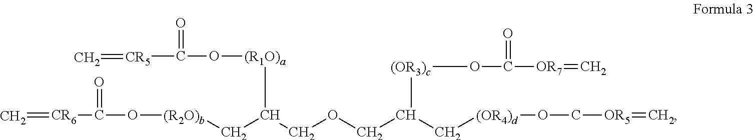

where: R₁, R₂, R₃, and R₄ are each independently a substituted or unsubstituted, linear or branched C₂ to C₅ alkylene group; R₅, R₆, R₇, and R₅ are each independently hydrogen or a methyl group; and a, b, c, and d are each independently 0 or an integer of 1 or more, 1≤a+b+c+d≤35.

In an embodiment, in Formula 2, —(OR₂)ₐ—, —(OR₃)_{b}—(OR₄)_{c}—, and —(ORₐ)— may be —(—O—CH₂CH₂—)—, —(—O—CH₂CH₂—)₂—, —(—O—CH₂CH₂—)₃—, —(—O—CH₂CH₂CH₂—)—, —(—O—CH₂CH₂CH₂—)₂—, —(—O—CH₂CH₂CH₂—)₃—, —(—O—CHCH₃CH₂—)—, —(—O—CHCH₃CH₂—)₂—, —(—O—CHCH₃CH₂—)₃—, —(—O—CH₂CH₂CH₂CH₂—)—, or —(—O—CH₂CH₂CH₂CH₂—)₂—.

In Formula 2, a+b+c may be an integer of 3 to 30, 3 to 12, or 3 to 9.

In an embodiment, in Formula 3, —(OR₁)ₐ—, —(OR₂)_{b}—, —(OR₃)_{c}—, and —(OR₄)_{d}— may be —(—O—CH₂CH₂—)—, —(—O—CH₂CH₂—)₂—, —(—O—CH₂CH₂—)₃—, —(—O—CH₂CH₂CH₂—)—, —(—O—CH₂CH₂CH₂—)₂—, —(—O—CH₂CH₂CH₂—)₃—, —(—O—CHCH₃CH₂—)—, —(—O—CHCH₃CH₂—)₂—, —(—O—CHCH₃CH₂—)₃—, —(—O—CH₂CH₂CH₂CH₂—)—, or —(—O—CH₂CH₂CH₂CH₂—)₂—.

Formula 3, a+b+c+d may be an integer of 3 to 30, 3 to 12, or 3 to 9.

For example, the alkylene glycol group-containing monomer may include at least one of the following Formulas 4 to 7:

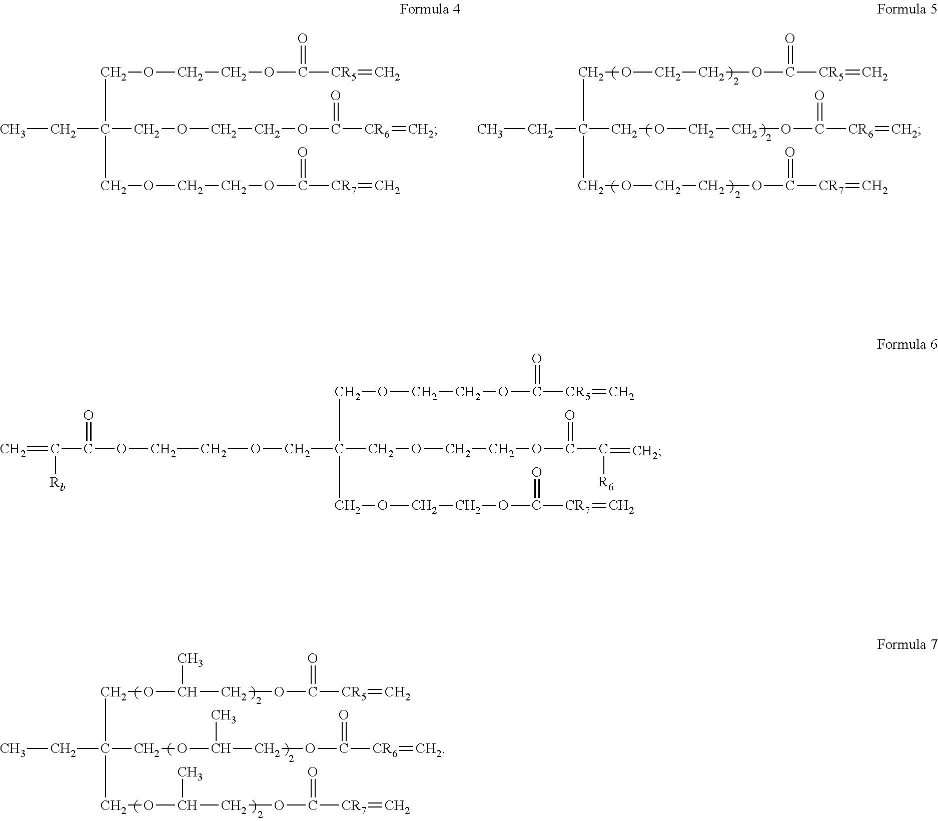

In Formulas 4 to 7, R₅, R₆, R₇, and Rb are each hydrogen or a methyl group.

In an embodiment, the matrix is formed of a composition for the matrix and the alkylene glycol group-containing monomer may be present in an amount of 3 wt % to 90 wt %, for example, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89 or 90 wt %, in the composition for the matrix in terms of solid content.

For example, the alkylene glycol group-containing monomer may be present in an amount of 10 wt % to 80 wt %, 10 wt % to 60 wt %, 20 wt % to 80 wt %, or 20 wt % to 60 wt %. Within this range, the effects of the present invention can be easily achieved.

The composition for the matrix may include the alkylene glycol group-containing monomer alone as a curable monomer, or may further include a mono- or higher functional monomer. In an embodiment, the mono- or higher functional monomer is an alkylene-free glycol monomer free from the alkylene glycol group.

The mono- or higher functional monomer can provide various effects including easy adjustment in viscosity of the composition for the matrix, improvement in scratch resistance and/or hardness of the optically functional layer, and the like. In an embodiment, the mono- or higher functional monomer may be a mono- to hexa-functional monomer or a bi- to hexa-functional monomer.

For example, the mono- or higher functional monomer may include: bifunctional (meth)acrylates, such as 1,4-butanediol di(meth)acrylate, 1,6-hexanediol di(meth)acrylate, dicyclopentanyl di(meth)acrylate, caprolactone-modified dicyclopentenyl di(meth)acrylate, ethylene oxide-modified di(meth)acrylate, di(meth)acryloxyethyl isocyanurate, allylated cyclohexyl di(meth)acrylate, tricyclodecane dimethanol (meth)acrylate, dimethylol dicyclopentane di(meth)acrylate, ethylene oxide-modified hexahydrophthalic acid di(meth)acrylate, tricyclodecane dimethanol (meth)acrylate, neopentyl glycol-modified trimethylpropane di(meth)acrylate, adamantane di(meth)acrylate, and 9,9-bis[4-(2-acryloyloxyethoxy)phenyl]fluorene; trifunctional (meth)acrylates, such as trimethylolpropane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, trifunctional urethane (meth)acrylates, and tris(meth)acryloxyethyl isocyanurate; tetrafunctional (meth)acrylates, such as diglycerin tetra(meth)acrylate and pentaerythritol tetra(meth)acrylate; pentafunctional (meth)acrylates, such as dipentaerythritol penta(meth)acrylate; and hexafunctional (meth)acrylates, such as dipentaerythritol hexa(meth)acrylate, caprolactone-modified dipentaerythritol hexa(meth)acrylate, and urethane (meth)acrylates (e.g. a reaction product of an isocyanate monomer and trimethylolpropane tri(meth)acrylate), without being limited thereto.

In an embodiment, the mono- or higher functional monomer may be present in an amount of 3 wt % to 90 wt %, for example, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89 or 90 wt %, and, in an embodiment, 20 wt % to 80 wt %, in the composition for the matrix in terms of solid content. Within this range, the effects of the present invention can be easily achieved.

The composition for the matrix may be a heat curable or photocurable composition. In an embodiment, the composition for the matrix is a photocurable composition and can secure good effects in improvement in hardness and scratch resistance of the optically functional layer.

The composition for the matrix may further include an initiator. For example, the initiator may include a heat initiator and/or a photoinitiator. The heat initiator may be an azo-based initiator, a peroxide-based initiator, or the like. The photoinitiator may be any of a photo-radical initiator, such as a phosphorus photoinitiator, a phosphine oxide photoinitiator, a ketone photoinitiator, a cyclohexyl ketone photoinitiator, and the like.

The composition for the matrix may further include a heat curable resin and/or a photocurable resin.

The heat curable resin is a resin capable of being cured by drying and/or heat treatment and may include a resin having a heat curable functional group, for example, any of a (meth)acrylate group, an epoxy group, a urethane group, a urethane (meth)acrylate group, and the like. For example, the heat curable resin may be a (meth)acrylic based resin. The photocurable resin is a resin capable of being cured by UV light and may include, for example, a resin having a photo-curable group. For example, the photocurable functional group may include a vinyl group, a (meth)acrylate group, and the like, and the photocurable resin may include at least one photocurable group selected from among these photocurable groups. For example, the photocurable resin may be selected from among resins capable of realizing the effects of the present invention, such as any of a (meth)acrylate based resin, a urethane (meth)acrylate based resin, an epoxy (meth)acrylate based resin, a silicone (meth)acrylate based resin, and the like.

The composition for the matrix may further include typical additives known to those skilled in the art, for example, leveling agents, surface modifiers, antistatic agents, dispersants, dyes, pigments, and the like.

The matrix may be an adhesive layer or a non-adhesive layer depending upon the composition for the matrix.

The matrix and the anisotropic particles, and, in an embodiment, the acicular particles, may have the same index of refraction or different indexes of refraction. In an embodiment, a difference in index of refraction therebetween is small, thereby causing no problem such as haze increase and the like.

For example, a difference in index of refraction between the anisotropic particles, and, in an embodiment, the acicular particles, and the matrix (the index of refraction of the anisotropic particles, and, in an embodiment, the acicular particles—the index of refraction of the matrix) may be 0.5 or less, for example, 0.3 or less, for example, 0 to 0.2.

The matrix may be directly formed on a protective layer or on the polarizer as described below. Herein, “directly formed” means that no adhesive, bonding, or tacky layer is interposed between the matrix and the protective layer or between the matrix and the polarizer.

Next, a method of alignment of the anisotropic particles, and, in an embodiment, the acicular particles, in the optically functional layer will be described.

The optically functional layer may be formed by coating a composition for the optically functional layer onto an adherend, followed by curing the composition. The composition for the optically functional layer may be prepared by mixing the anisotropic particles, for example, the acicular particles, with the composition for the matrix. Here, the orientation of the acicular particles in the optically functional layer may be realized by adjusting viscosity of the composition for optically functional layers. The viscosity of the composition may be adjusted by adjusting the content of the solvent in the composition for the optically functional layer, but is not limited thereto. In addition, the orientation of the acicular particles in the optically functional layer may also be realized by adjusting pressure or the like upon coating the composition.

When the composition for the optically functional layer has an excessively high viscosity, the acicular particles cannot be properly aligned during coating, or cannot reach the average value and standard deviation of the orientation angles according to the present invention, even if aligned. A desired viscosity may be changed according to the content and length of the acicular particles in the optically functional layer, and the like.

In an embodiment, the optically functional layer may have a thickness of 3 μm to 50 μm, and, in an embodiment, 5 μm to 20 μm, and, in an embodiment, 5 μm to 15 μm.

In an embodiment, the optically functional layer may be formed by coating the composition for the optically functional layer onto a surface of an adherend, protective layer or polarizer, followed by photocuring. Photocuring and coating may be performed by typical methods known to those skilled in the art.

### Polarizing Plate

The polarizing plate may further include one or more polarizers, protective layers (including a retardation layer), adhesive layers and/or bonding layers, functional films (functional coating layer), and the like, in addition to the optically functional layer.

### (i) Polarizer

The polarizer is a linear light absorption type polarizer and may provide a polarization function by allowing a light component traveling in a direction to pass therethrough while absorbing a light component perpendicular to the direction among light incident thereon.

The polarizer may be a polarizer fabricated by dyeing and stretching a polyvinyl alcohol (PVA) based film or a polyene-based polarizer fabricated by dehydration of the polyvinyl alcohol based film.

In an embodiment, the polarizer may have a thickness of 50 μm or less, for example, 5 μm to 30 μm. Within this range, a film for the polarizer does not suffer from melting and fracture upon stretching of the film.

### (ii) Protective Layer

The protective layer may be provided to the polarizing plate to protect the polarizer or to increase mechanical strength of the polarizing plate. The protective layer may be an adherend for forming an optically functional layer.

The protective layer may include a transparent base. The transparent base may have a higher or lower index of refraction than the optically functional layer. In an embodiment, the transparent base has a higher index of refraction than the optically functional layer. With this structure, the protective layer can assist in improvement in contrast ratio and brightness.

The transparent base may include an optically transparent resin film having a light incidence surface and a light exit surface facing the light incidence surface. The transparent base may be composed of a single layer of a resin film or multiple resin layers stacked one above another. The resin may include at least one selected from among a cellulose ester based resin including triacetylcellulose (TAC) and the like, a cyclic polyolefin based resin including an amorphous cyclic olefin polymer (COP) and the like, a polycarbonate based resin, a polyester based resin including polyethylene terephthalate (PET) and the like, a polyether sulfone based resin, a polysulfone based resin, a polyamide based resin, a polyimide based resin, a non-cyclic polyolefin based resin, a polyacrylate based resin including poly(methyl methacrylate) and the like, a polyvinyl alcohol based resin, a polyvinyl chloride based resin, and a polyvinylidene chloride based resin, without being limited thereto. In an embodiment, the transparent base may include a polyester based resin including polyethylene terephthalate (PET) and the like to further improve contrast ratio and brightness.

In an embodiment, the transparent base may have a haze of 30% or less, and, in an embodiment, 2% to 30%, and a light transmittance of 90% or more, and, in an embodiment, 95% to 100%. Within this range, the transparent base can be used in the polarizing plate.

In an embodiment, the transparent base may have a thickness of 5 μm to 200 μm, for example 30 μm to 120 μm. Within this range, the transparent base can be used in the polarizing plate.

In an embodiment, the protective layer may be composed of the transparent base alone. In another embodiment, the protective layer may further include a functional layer on at least one surface of the transparent base. The functional coating layer may include at least one selected from among a primer layer, an antiglare layer, an antireflection layer, a low refractivity layer, a high refractivity layer, a hard coating layer, an anti-fingerprint layer, and the like.

The protective layer may be an isotropic film providing substantially no phase retardation, or may have a range (e.g., a predetermined range) of in-plane retardation to provide an additional function when combined with the polarizing plate.

In an embodiment, the protective layer may have an in-plane retardation of 3,000 nm or more at a wavelength of 550 nm. Within this range, the protective layer can assist in improvement in contrast ratio and/or brightness when combined with the optically functional layer. In an embodiment, the protective layer has an in-plane retardation of 4,000 nm or more, 8,000 nm or more, and, in an embodiment, 10,000 nm or more, and, in an embodiment, greater than 10,000 nm, and, in an embodiment, 10,100 nm to 30,000 nm, and, in an embodiment, 10,100 nm to 15,000 nm, at a wavelength of 550 nm.

In another embodiment, the protective layer may have an in-plane retardation of less than 3,000 nm at a wavelength of 550 nm. For example, the protective layer may have an in-plane retardation of 0 nm to 1,000 nm, and, in an embodiment, 10 nm to 500 nm, at a wavelength of 550 nm.

The protective layer may be a first protective layer, a second protective layer, a third protective layer, or the like.

(iii) Adhesive Layer and/or Bonding Layer

The adhesive layer and/or the bonding layer may adhesively attach or bond the polarizer, the optically functional layer, the protective layer, and the functional film to one another.

The adhesive layer may be formed of a typical composition known to those skilled in the art. For example, the adhesive layer may be a (meth)acrylic based adhesive layer, an epoxy based adhesive layer, a silicone based adhesive layer, a urethane based adhesive layer, an epoxy (meth)acrylic based adhesive layer, or a urethane (meth)acrylic based adhesive layer. By way of example, the adhesive layer may be a pressure sensitive adhesive (PSA) layer.

The bonding layer may be formed of a typical composition known to those skilled in the art. For example, the bonding layer may be formed of a water-based bonding agent, a photo-curable bonding agent, and the like.

(iv) Functional Film and/or Functional Coating Layer

Although the polarizing plate may omit a functional film, the functional film may provide an additional function to the polarizing plate.

The functional film and the functional coating layer may be an anti-glare film, an antireflection film, an ultra-low reflectivity film, a low refractivity film, a high refractivity film, or an anti-fingerprint film.

FIG. 5 to FIG. 9 are cross-sectional views of polarizing plates according to embodiments of the present invention.

The polarizing plate may include: a polarizer 20; and an optically functional layer 10 formed on a light exit surface of the polarizer 20. The optically functional layer 10 may include acicular particles 1 and a matrix 2.

With reference to FIG. 6, the polarizing plate may include: a polarizer 20; and an optically functional layer 10 and a first protective layer 30 sequentially stacked on a light exit surface of the polarizer 20. In an embodiment, the first protective layer 30 may further include a coating layer, for example, an anti-glare layer, an antireflection layer, an ultra-low reflectivity layer, a low refractivity layer, a high refractivity layer, or an anti-fingerprint layer, on an opposite surface of the optically functional layer 10, that is, on an upper surface thereof.

With reference to FIG. 7, the polarizing plate may include: a polarizer 20; and a first protective layer 30 and an optically functional layer 10 sequentially stacked on a light exit surface of the polarizer 20.

In an embodiment, a thickness ratio of the optically functional layer to the first protective layer (a thickness of the optically functional layer:a thickness of the first protective layer) may be in a range from 1:1 to 1:20, for example, 1:5 to 1:10. Within this range, the effects of the present invention can be easily realized.

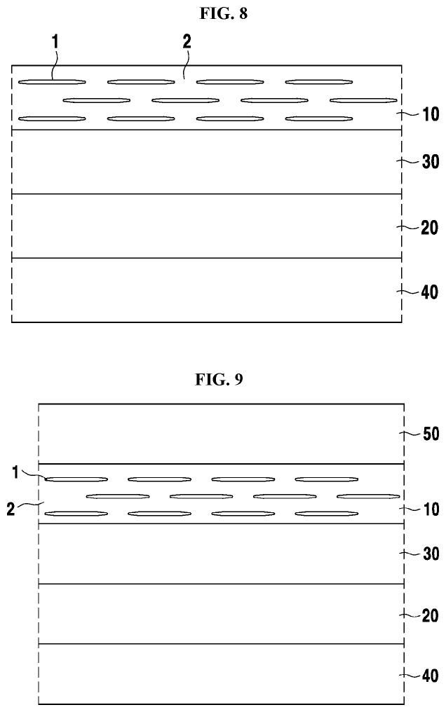

With reference to FIG. 8, the polarizing plate may include: a polarizer 20; a first protective layer 30 and an optically functional layer 10 sequentially stacked on a light exit surface of the polarizer 20; and a second protective layer 40 formed on a light incidence surface of the polarizer 20.

In an embodiment, a thickness ratio of the optically functional layer to the first protective layer may be in a range from 1:1 to 1:20, for example, 1:5 to 1:10. Within this range, the effects of the present invention can be easily realized.

With reference to FIG. 9, the polarizing plate may include: a polarizer 20; a first protective layer 30, an optically functional layer 10, and a functional coating layer 50 sequentially stacked on a light exit surface of the polarizer 20; and a second protective layer 40 formed on a light incidence surface of the polarizer 20. The functional coating layer 50 may include at least one selected from among, for example, an anti-glare layer, an antireflection layer, an ultra-low reflectivity layer, a low refractivity layer, a high refractivity layer, and an anti-fingerprint layer.

In an embodiment, a thickness ratio of the optically functional layer to the first protective layer may be in a range from 1:1 to 1:20, for example, 1:5 to 1:10. Within this range, the effects of the present invention can be easily realized.

Although not shown in FIG. 5 to FIG. 9, the layers of the polarizing plate may be stacked one above another via an adhesive layer, a bonding layer, and the like. In addition, although not shown in FIG. 5 to FIG. 9, the polarizing plate may further include a third protective layer between layers thereof.

An optical display apparatus according to one or more embodiments of the present invention includes the polarizing plate according to an embodiment of the present invention.

In an embodiment, the optical display apparatus may include the polarizing plate according to an embodiment of the present invention as a viewer-side polarizing plate with respect to a liquid crystal panel. Here, the viewer-side polarizing plate refers to a polarizing plate disposed at an opposite side to a screen, that is, to a light source, with respect to the liquid crystal panel.

In an embodiment, a liquid crystal display may include a light-collecting backlight unit, a light source-side polarizing plate, a liquid crystal panel, and a viewer-side polarizing plate sequentially stacked in the stated order, in which the viewer-side polarizing plate includes the polarizing plate according to the present invention. The light source-side polarizing plate refers to a polarizing plate disposed at a light source side. The liquid crystal panel may adopt a vertical alignment (VA) mode, an IPS mode, a patterned vertical alignment (PVA) mode, or a super-patterned vertical alignment (S-PVA) mode, without being limited thereto.

The optical display apparatus may be a foldable or flexible optical display apparatus, or a non-foldable or non-flexible optical display apparatus.

Next, the present invention will be described in further detail with reference to some examples. However, it is to be understood that these examples are provided for illustration and are not to be construed in any way as limiting the present invention.

### Example 1

(1) A mixture of CaCO₃ particles (acicular anisotropic microparticles, length: 10 μm to 30 μm, cross-sectional diameter: 0.5 μm to 2.0 μm, index of refraction: 1.68, Whiscal A, Maruo Calcium Co., Ltd.) was added to a methyl ethyl ketone solution containing KBM503 (3-methacryloxypropyltrimethoxysilane, Shin-Etsu Chemical Co., Ltd.), followed by reaction at room temperature. Next, the resulting product was dried in an oven at 90° C. to remove the solvent, followed by surface modification with 3-methacryloxypropyltrimethoxysilane to prepare a mixture of the surface-modified CaCO₃ particles (acicular anisotropic microparticles), which in turn was mixed with methyl ethyl ketone, thereby preparing a mixed solution of the surface-modified CaCO₃ acicular particles and methyl ethyl ketone.

A photoinitiator-containing solution (photoinitiator being in a dissolved state) was prepared by mixing 3 parts by weight of a photoinitiator (Irgacure 184, solid phase, alpha-hydroxyketone photoinitiator) with 25 parts by weight of a solvent (2-methoxy ethanol), followed by sufficiently stirring the mixture at 800 rpm at room temperature for 30 minutes.

10 parts by weight of dipentaerythritol hexaacrylate, 10 parts by weight of pentaerythritol triacrylate (M340, Miwon Industry Co., Ltd.), and 11 parts by weight of ethoxylated trimethylolpropane triacrylate (A-TMPT-3EO, 3 moles of ethylene glycol groups per molecule) were added to the photoinitiator-containing solution and stirred at 700 rpm for 20 minutes, followed by adding 29.8 parts by weight of methyl ethyl ketone to the resulting mixture, which in turn was stirred for 20 minutes. Next, 0.2 parts by weight of a leveling agent (polyether-modified polydimethylsiloxane, BYK 306, BYK Chemie) was added to the resulting mixture, which in turn was stirred at 400 rpm for 10 minutes, thereby preparing a composition for a matrix. Next, a composition for optically functional layers was prepared by adding 11 parts by weight of the mixed solution of the surface-modified CaCO₃ acicular particles and methyl ethyl ketone to the composition for the matrix, followed by viscosity adjustment and stirring the solution using a homogenizer for 4 hours.
(2) A polarizer (thickness: 13 μm, light transmittance: 44%) was prepared by stretching a polyvinyl alcohol film to 3 times an initial length thereof at 60° C. in the MD of the film, dyeing the stretched film with iodine, and stretching the dyed film to 2.5 times in an aqueous solution of boric acid at 40° C. in the MD thereof.
(3) A cyclic olefin polymer (COP) film (ZEON) was bonded to a lower surface of the prepared polarizer via a bonding agent (Z-200, Nippon Goshei Co., Ltd.). Next, a polyethylene terephthalate film (TA044, Glare PET, thickness: 80 μm, TOPPAN) was bonded to an upper surface of the polarizer via a bonding agent (Z-200, Nippon Goshei Co., Ltd.). Next, the composition for optically functional layers was coated on an upper surface of the PET film, dried in a drying oven at 90° C. for 3 minutes and cured through irradiation with UV light at the PET side to form an optically functional layer (thickness: 10 μm), thereby preparing a polarizing plate in which the optically functional layer, the PET film, the bonding layer, the polarizer, the bonding layer, and the COP film are sequentially stacked in the stated order. In the optically functional layer, the CaCO₃ acicular particles were aligned at orientation angles having an average value of +1.2° and a standard deviation of 7.2°.

### Example 2

A polarizing plate was manufactured in the same manner as in Example 1 except that 11 parts by weight of ethoxylated trimethylolpropane triacrylate (A-TMPT-6EO, 6 moles of ethylene glycol groups per molecule) was used instead of 11 parts by weight of ethoxylated trimethylolpropane triacrylate (A-TMPT-3EO, 3 moles of ethylene glycol groups per molecule) in preparation of the composition for optically functional layers.

### Example 3

A polarizing plate was manufactured in the same manner as in Example 1 except that 11 parts by weight of ethoxylated trimethylolpropane triacrylate (A-TMPT-9EO, 9 moles of ethylene glycol groups per molecule) was used instead of 11 parts by weight of ethoxylated trimethylolpropane triacrylate (A-TMPT-3EO, 3 moles of ethylene glycol groups per molecule) in preparation of the composition for optically functional layers.

### Example 4

A polarizing plate was manufactured in the same manner as in Example 1 except that 11 parts by weight of propoxylated trimethylolpropane triacrylate (A-TMPT-6PO, 6 moles of propylene glycol groups per molecule) was used instead of 11 parts by weight of ethoxylated trimethylolpropane triacrylate (A-TMPT-3EO, 3 moles of ethylene glycol groups per molecule) in preparation of the composition for optically functional layers.

### Example 5

A photoinitiator-containing solution (photoinitiator being in a dissolved state) was prepared by mixing 3 parts by weight of a photoinitiator (Irgacure 184, solid phase, alpha-hydroxyketone photoinitiator) with 25 parts by weight of a solvent (2-methoxy ethanol), followed by sufficiently stirring the mixture at 800 rpm at room temperature for 30 minutes.

12.5 parts by weight of dipentaerythritol hexaacrylate, 12.5 parts by weight of pentaerythritol triacrylate (M340, Miwon Industry Co., Ltd.), and 6 parts by weight of ethoxylated trimethylolpropane triacrylate (A-TMPT-3EO, 3 moles of ethylene glycol groups per molecule) were added to the photoinitiator-containing solution and stirred at 700 rpm for 20 minutes, followed by adding 39.8 parts by weight of isopropyl alcohol to the resulting mixture, which in turn was stirred for 20 minutes. Next, 0.2 parts by weight of a leveling agent (polyether-modified polydimethylsiloxane, BYK 306, BYK Chemie) was added to the resulting mixture, which in turn was stirred at 400 rpm for 10 minutes, thereby preparing a composition for a matrix. Next, a composition for optically functional layers was prepared by adding 11 parts by weight of the mixed solution of the surface-modified CaCO₃ acicular particles and methyl ethyl ketone prepared in Example 1 to the composition for the matrix, followed by adjustment in viscosity and stirring the resulting solution using a homogenizer for 4 hours. Thereafter, a polarizing plate was manufactured in the same manner as in Example 1 using the prepared composition for optically functional layers.

### Example 6

A polarizing plate was manufactured in the same manner as in Example 5 except that 6 parts by weight of ethoxylated trimethylolpropane triacrylate (A-TMPT-6EO, 6 moles of ethylene glycol groups per molecule) was used instead of 6 parts by weight of ethoxylated trimethylolpropane triacrylate (A-TMPT-3EO, 3 moles of ethylene glycol groups per molecule) in preparation of the composition for optically functional layers.

### Example 7

A polarizing plate was manufactured in the same manner as in Example 5 except that 6 parts by weight of ethoxylated pentaerythritol tetraacrylate (ATM-4E, 4 moles of ethylene glycol groups per molecule) was used instead of 6 parts by weight of ethoxylated trimethylolpropane triacrylate (A-TMPT-3EO, 3 moles of ethylene glycol groups per molecule) in preparation of the composition for optically functional layers.

### Example 8

A polarizing plate was manufactured in the same manner as in Example 1 except that viscosity of the composition for optically functional layers was changed by changing the content of the solvent in the composition for optically functional layers.

### Example 9

A polarizing plate was manufactured in the same manner as in Example 1 except that viscosity of the composition for optically functional layers was changed by changing the content of the solvent in the composition for optically functional layers.

### Comparative Example 1

A polarizing plate was manufactured in the same manner as in Example 1 except that 11 parts by weight of trimethylolpropane triacrylate (A-TMPT, no alkylene glycol group) was used instead of 11 parts by weight of ethoxylated trimethylolpropane triacrylate (A-TMPT-3EO) in preparation of the composition for optically functional layers.

### Comparative Example 2

A polarizing plate was manufactured in the same manner as in Example 1 except that 11 parts by weight of isobornyl acrylate (no alkylene glycol group) was used instead of 11 parts by weight of ethoxylated trimethylolpropane triacrylate (A-TMPT-3EO) in preparation of the composition for optically functional layers.

### Comparative Example 3

A polarizing plate was manufactured in the same manner as in Example 1 except that 11 parts by weight of urethane acrylate (EB284, no alkylene glycol group) was used instead of 11 parts by weight of ethoxylated trimethylolpropane triacrylate (A-TMPT-3EO) in preparation of the composition for optically functional layers,

### Comparative Example 4

A polarizing plate was manufactured in the same manner as in Example 1 except that 10 parts by weight of a mixed solution of isotropic spherical particles (MSP080, silicone bead, diameter: 0.8 μm, Nikko Rica Co., Ltd.) and methyl ethyl ketone was used instead of 11 parts by weight of the mixed solution of the surface-modified CaCO₃ acicular particles and methyl ethyl ketone in preparation of the composition for optically functional layers.

### Reference Example 1

A polarizing plate including a COP film, a polarizer, and a PET film (TA044) sequentially stacked in the stated order without an optically functional layer was prepared with reference to Example 1. This polarizing plate was used as a light source-side polarizing plate in fabrication of a module for liquid crystal displays.

### Adhesive Layer

An adhesive composition was prepared by mixing an acrylic copolymer adhesive (N9695, Nippon Synthetic Chemical Industrial Co., Ltd.) with a diluted solvent (methyl ethyl ketone), followed by stirring the mixture at 500 rpm for 30 minutes. Then, the adhesive composition was deposited onto a release film and cured, thereby forming an adhesive layer. The adhesive layer was used upon assembling a viewer-side polarizing plate and a light-source side polarizing plate to a panel.

Models for property evaluation were fabricated using the polarizing plates of the Examples and Comparative Examples and were evaluated as to properties of Table 1.

After removing the viewer-side polarizing plate and the light source-side polarizing plate from a liquid crystal panel model (55″ UN55KS8000F, Samsung Electronics Co., Ltd.), each of the polarizing plates fabricated in the Examples and Comparative Examples was attached as a viewer-side polarizing plate, and the polarizing plate of Reference Example 1 was attached as a light source-side polarizing plate to the liquid crystal panel model to fabricate a model for property evaluation.

The following properties were evaluated and results are shown in Table 1.
(1) Average value and standard deviation of orientation angles: A surface image of each of the optically functional layers formed in the Examples and Comparative Examples was captured using an optical microscope (Olympus MX61L, magnification: 500×(10×50)) and adjusted in height to be focused on the surface of the optically functional layer, followed by executing the FIJI program (Method: Fourier Components, N bis: 90°, histogram start: 0°, histogram end:180°), thereby obtaining an average value and a standard deviation of the orientation angles of the acicular particles.
(2) Frontal relative brightness (unit: %) and lateral relative contrast ratio (unit: %): A liquid crystal display (having the same configuration as Samsung TV (55″, Model: UN55KS8000F) except for the configuration of the liquid crystal display module of the Examples and Comparative Examples) including a one-side edge type LED light source was fabricated by assembling an LED light source, a light guide plate, and the model for measurement of viewing angle. Brightness and contrast ratios at a front side (0°, 0°) and a lateral side (0°, 60°) were measured in the spherical coordinate system using an EZCONTRAST X88RC (EZXL-176R-F422A4, ELDIM S.A.). Frontal relative brightness was calculated according to Formula: Frontal relative brightness={(brightness of each of the liquid crystal displays of the Examples, Comparative Examples, and Reference Example 1)/(brightness of Reference Example 1)}×100. Lateral relative brightness was calculated by a ratio of lateral brightness in a white mode to lateral brightness in a black mode. In addition, lateral relative contrast ratio was calculated according to Formula: Lateral relative contrast ratio={(contrast ratio of each of the liquid crystal displays of the Examples, Comparative Examples, and Reference Example 1)/(contrast ratio of Reference Example 1)}×100. The frontal relative contrast ratio may be 65% or more, and, in an embodiment, 71% or more. The lateral relative contrast ratio may be, for example, 115% or more, and, in an embodiment, 120% or more.
(3) Pencil hardness (no unit): Each of the polarizing plates fabricated in the Examples and Comparative Examples was attached to a glass plate, followed by measurement of pencil hardness on the outermost surface thereof using a pencil hardness tester (CT-PC2, Core Technology Co., Ltd.) in accordance with ASTM D3502. When a specimen suffered from generation of scratches 3 times or more upon scratching 5 times under a load of 200 g at an angle of 45° while increasing pencil hardness, it was determined that scratches were generated at the corresponding pencil hardness. When an initial pencil hardness causing generation of scratches on a specimen is 3H, the specimen had a pencil hardness of 2H. When an initial pencil hardness causing generation of scratches on a specimen is 2H, the specimen had a pencil hardness of H.
(4) Scratch resistance (no unit): Each of the polarizing plates fabricated in the Examples and Comparative Examples was cut into a rectangular specimen having a size of 150 mm×25 mm, which in turn was attached to a glass plate via an adhesive layer. Then, scratch resistance was evaluated by reciprocating Steel wool #0000 15 times on a surface of the optically functional layer under a load of 100 g. Generation of no scratch was rated as “O” and generation of scratches was rated as “X”.
(5) Bendability (unit: mm): Each of the polarizing plates fabricated in the Examples and Comparative Examples was cut into a rectangular specimen such that the polarizer had a size of 150 mm×25 mm (MD×TD). The specimen was wound on a mandrel rod such that COP film of the polarizing plate contacted the mandrel rod (having a circular cross-section), and was left at room temperature for 5 seconds to evaluate generation of cracks over the entirety of the polarizing plate. An initial diameter of the mandrel rod allowing generation of cracks was evaluated by changing the diameter of the mandrel rod.
(6) Curl (unit: mm): Each of the polarizing plates fabricated in the Examples and Comparative Examples was cut into a rectangular specimen having a size of 100 mm×100 mm and was placed on a flat floor such that the optically functional layer faced upward. Then, the specimen was left at 25° C. for 5 days, followed by measuring the maximum height of the specimen bent from the floor.

TABLE 1

| | | | | | | | | | | | | | | | Reference |
|---|---|---|---|---|---|---|---|---|---|---|---|---|---|---|---|
| | | Example | | | | | | | | | Comparative Example | | | | Example |
| | | 1 | 2 | 3 | 4 | 5 | 6 | 7 | 8 | 9 | 1 | 2 | 3 | 4 | 1 |
| Content of | | 3.0 | 3.0 | 3.0 | 3.0 | 3.0 | 3.0 | 3.0 | 3.0 | 3.0 | 3.0 | 3.0 | 3.0 | 3.0 | — |
| particles | | | | | | | | | | | | | | | |
| Orientation | Average | +1.2 | +1.3 | −1.2 | +2.3 | +1.2 | +1.3 | −1.2 | +10.3 | +1.2 | +2.3 | +1.2 | +2.3 | — | — |
| angle (°) | Standard | 7.2 | 7.8 | 5.8 | 6.9 | 6.9 | 8.1 | 7.2 | 7.2 | 17.8 | 7.2 | 7.8 | 7.2 | — | — |
| | deviation | | | | | | | | | | | | | | |
| Frontal | Brightness | 378.1 | 376.1 | 372.1 | 374.2 | 2371.3 | 377.5 | 373.8 | 367.1 | 356.6 | 375.2 | 374.8 | 376.9 | 545.5 | 524.5 |
| | Relative | 72 | 72 | 71 | 71 | 71 | 72 | 71 | 70 | 68 | 72 | 71 | 72 | 104 | 100 |
| | brightness | | | | | | | | | | | | | | |
| Lateral | Contrast | 336.5 | 337.1 | 332.8 | 339.5 | 334.9 | 329.9 | 331.8 | 327.3 | 316.3 | 333.6 | 332.9 | 339.1 | 269.5 | 275 |
| | ratio | | | | | | | | | | | | | | |
| | Relative | 122 | 123 | 121 | 123 | 122 | 120 | 121 | 119 | 115 | 121 | 121 | 123 | 98 | 100 |
| | contrast | | | | | | | | | | | | | | |
| | ratio | | | | | | | | | | | | | | |

| | | | | | | | | | | | | | | |
|---|---|---|---|---|---|---|---|---|---|---|---|---|---|---|
| Pencil hardness | 2H | 2H | 2H | 2H | 2H | 2H | 2H | 2H | 2H | 2H | 1H | 1H | 2H | — |
| Scratch | ◯ | ◯ | ◯ | ◯ | ◯ | ◯ | ◯ | ◯ | ◯ | ◯ | X | X | ◯ | — |
| resistance | | | | | | | | | | | | | | |
| Bendability | 8 | 8 | 8 | 8 | 8 | 8 | 8 | 8 | 8 | 16 | 6 | 6 | 8 | — |
| Curl | 12 | 13 | 11 | 11 | 12 | 11 | 11 | 12 | 12 | 51 | 9 | 9 | 12 | — |

*Particle content: The content of acicular particles (CaCO₃) or isotropic spherical particles (silicone beads) in the optically functional layer

As shown in Table 1, the polarizing plates according to the present invention exhibited frontal contrast ratios and lateral contrast ratios similar to those of a polarizing plate having a pattern or a contrast ratio-enhancing layer including resin layers having a pattern therebetween. In addition, the polarizing plates according to the present invention achieved improvement in bendability and curl suppression. Accordingly, although not shown in Table 1, it is anticipated that the polarizing plate according to the present invention will provide good processability in transfer and attachment of the polarizing plate to a panel. Further, the polarizing plates according to the present invention exhibited good scratch resistance and hardness. In particular, the polarizing plates of Examples 1 to 7, in which the average of the orientation angles of the acicular particles was in the range of −10° to +10° and the standard deviation of the orientation angles of the acicular particles was 15° or less, had lower lateral contrast ratios than the polarizing plates of Examples 8 and 9, which failed to satisfy the average and standard deviation of the orientation angles of the acicular particles according to the present invention.

By contrast, the polarizing plate of Comparative Example 4 including the isotropic spherical particles instead of the acicular particles had lateral relative contrast ratio too low to be used. The polarizing plate of Comparative Example 1 including an alkylene glycol group-free matrix had poor bendability and high curl. The polarizing plate of Comparative Example 2 including an alkylene glycol group-free matrix had too low hardness and scratch resistance.

Although some example embodiments have been described herein, it is to be understood that various modifications, changes, alterations, and equivalent embodiments can be made by those skilled in the art without departing from the spirit and scope of the invention.

What is claimed is:

1. A polarizing plate comprising: a polarizer; and an optically functional layer formed on a surface of the polarizer,
wherein the optically functional layer comprises an alkylene glycol group-containing matrix and anisotropic particles comprising acicular particles,
the acicular particles being aligned with respect to a light absorption axis of the polarizer in an in-plane direction of the optically functional layer.

2. The polarizing plate as claimed in claim 1, wherein the optically functional layer is a contrast ratio, visibility, or brightness-enhancing layer.

3. The polarizing plate as claimed in claim 1, wherein each of upper and lower surfaces of the optically functional layer are flat surfaces.

4. The polarizing plate as claimed in claim 1, wherein the acicular particles are acicular microparticles.

5. The polarizing plate as claimed in claim 1, wherein the acicular particles are formed of at least one selected from among titanium oxide, zirconium oxide, zinc oxide, calcium carbonate, Boehmite, aluminum borate, calcium silicate, magnesium sulfate, magnesium sulfate hydrate, and potassium titanate.

6. The polarizing plate as claimed in claim 1, wherein the acicular particles are present in an amount of 1 wt % to 30 wt % in the optically functional layer.

7. The polarizing plate as claimed in claim 1, wherein, assuming that a light absorption axis of the polarizer is 0°, orientation angles of the acicular particles defined between longitudinal directions of the acicular particles and the light absorption axis of the polarizer have an average value of −10° to +10° and a standard deviation of 15° or less.

8. The polarizing plate as claimed in claim 1, wherein the acicular particles are acicular particles subjected to surface modification.

9. The polarizing plate as claimed in claim 1, wherein the acicular particles are impregnated into the matrix.

10. The polarizing plate as claimed in claim 1, wherein the alkylene glycol group is represented by Formula 1: 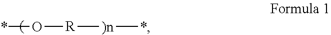
where * is a linking site between elements; R is a substituted or unsubstituted, linear or branched C₁ to C₅ alkylene group; and n is an integer of 1 or more.

11. The polarizing plate as claimed in claim 10, wherein the alkylene glycol group is —(—O—CH₂CH₂—)—, —(—O—CH₂CH₂—)₂—, —(—O—CH₂CH₂—)₃—, —(—O—CH₂CH₂CH₂—)—, —(—O—CH₂CH₂CH₂—)₂—, —(—O—CH₂CH₂CH₂—)₃—, —(—O—CHCH₃CH₂—)—, —(—O—CHCH₃CH₂—)₂—, —(—O—CHCH₃CH₂—)₃—, —(—O—CH₂CH₂CH₂CH₂—)—, —(—O—CH₂CH₂CH₂CH₂—)₂—, or —(—O—CH₂CH₂CH₂CH₂—)₃—.

12. The polarizing plate as claimed in claim 1, wherein the alkylene glycol group is derived from an alkylene glycol group-containing monomer.

13. The polarizing plate as claimed in claim 12, wherein the alkylene glycol group-containing monomer comprises at least one selected from among compounds represented by Formulas 2 and 3: 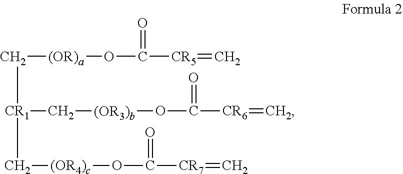
where:
R₁ is hydrogen, a C₁ to C₅ alkyl group, or *—CH₂—(—ORₐ—)—O—(C═O)—CR_{b}═CH₂ (*being a linking site between elements, Ra being a C₂ to C₅ alkylene group, Rb being hydrogen or a methyl group);
R₂, R₃, and R₄ are each independently a substituted or unsubstituted, linear or branched C₂ to C₅ alkylene group;
R₅, R₆, and R₇ are each independently hydrogen or a methyl group; and
a, b, and c are each independently 0 or an integer of 1 or more, 1≤a+b+c≤ 35; 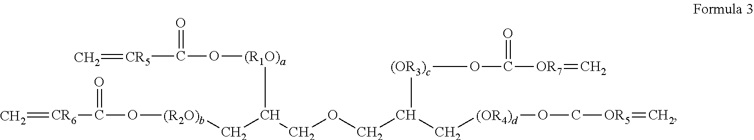
where:
R₁, R₂, R₃, and R₄ are each independently a substituted or unsubstituted, linear or branched C₂ to C₅ alkylene group;
R₅, R₆, R₇, and R₅ are each independently hydrogen or a methyl group; and
a, b, c, and d are each independently 0 or an integer of 1 or more, 1≤a+b+C+d≤35.

14. The polarizing plate as claimed in claim 12, wherein the alkylene glycol group-containing monomer is present in an amount of 3 wt % to 90 wt % in a composition for the matrix in terms of solid content.

15. The polarizing plate as claimed in claim 1, wherein the polarizing plate comprises at least one selected from among a protective layer, an adhesive layer, a bonding layer, a functional film, and a functional coating layer.

16. The polarizing plate as claimed in claim 15, wherein each of the functional film and the functional coating layer is an anti-glare layer, an anti-reflection layer, an ultra-low reflectivity layer, a low refractivity layer, a high refractivity layer, or an anti-fingerprint layer.

17. The polarizing plate as claimed in claim 1, comprising: the polarizer; a first protective layer and the optically functional layer sequentially stacked on a light exit surface of the polarizer; and a second protective layer on a light incidence surface of the polarizer.

18. The polarizing plate as claimed in claim 1, comprising: the polarizer; a first protective layer, the optically functional layer, and a functional coating layer sequentially stacked on a light exit surface of the polarizer; and a second protective layer on a light incidence surface of the polarizer.

19. An optical display apparatus comprising the polarizing plate as claimed in claim 1.
